(19) United States
(12) Patent Application Publication
(10) Pub. No.: US 2015/0128243 A1
(43) Pub. Date: May 7, 2015

(54) METHOD OF AUTHENTICATING A DEVICE AND ENCRYPTING DATA TRANSMITTED BETWEEN THE DEVICE AND A SERVER

(71) Applicant: Oltio (Proprietary) Limited, Morningside (ZA)

(72) Inventors: Petrus Daniel Jacobus Roux, Centurion (ZA); Paul Andrew Selibas, Johannesburg (ZA); Dirk Marinus Bruynse, Sandton (ZA)

(21) Appl. No.: 14/383,755

(22) PCT Filed: Mar. 8, 2013
(86) PCT No.: PCT/IB13/51844

§ 371 Date: Sep. 8, 2014

(30) Foreign Application Priority Data
Mar. 8, 2012 (ZA) 2012/01706

(51) Int. Cl. H04L 29/06

(52) U.S. Cl. CPC H04L 63/0853
USPC 726/9

(57) ABSTRACT

A method of authenticating a device for secure communications between the device and a server comprises transmitting a security token request via a data communications network using a data communications protocol. A message is received from the device that no security token is available. In response, an identification request is transmitted from the server to the device via the data communications network and an identification message is received from the device via a mobile communications network using a mobile communications protocol, the identification message including an identification of the device. The identification of the device is stored in a memory. A security token is generated and transmitted to the device via the data communications network. The security token is stored associated with the identification of the device in a memory connected to the server for use in future secure communications with the device via the data communications network.

### BACKGROUND OF THE INVENTION

THIS invention relates to a method of authenticating a device for secure communications between the device and a server and further for encrypting data transmitted between the device and the server, particularly to a mobile communications device.

Mobile communications devices such as mobile telephones include a mobile communications network access device which is typically in the form of a subscriber identity module (SIM). The SIM is an integrated circuit that securely stores a service-subscriber key (IMSI) used to identify a subscriber on a mobile telephony device and allows a device using the SIM access to the mobile network.

Add-on services using the mobile device 10 which require authentication of the device and encryption of data transmitted to and from the device typically use the authentication and encryption capabilities built into the SIM as this is very secure. However, this requires the co-operation and permission of the mobile network operator (MNO) to access the MNO's back-end infrastructure, access one or more cryptographic keys and functions on the SIM, and load propriety cryptographic keys and logic on the SIM.

The present invention seeks to provide an alternative method which allows an acceptable level of security in terms of authenticating the mobile device 10 and encrypting data transmitted between the device and a server 12 without using the SIM for authentication and encryption thus removing the need for co-operation and approval by the mobile network operator.

### SUMMARY OF THE INVENTION

A method of authenticating a device for secure communications between the device and a server, the method comprising:
transmitting a security token request via a data communications network using a data communications protocol;
receiving a message from the device that no security token is available;
transmitting an identification request from the server to the device via the data communications network using the data communications protocol;
receiving an identification message from the device via a mobile communications network using a mobile communications protocol, the identification message including an identification of the device;
storing the identification of the device in a memory;
generating a security token and transmitting the security token to the device via the data communications network using the data communications protocol; and
storing the security token associated with the identification of the device in a memory connected to the server for use in future secure communications with the device via the data communications network using the data communications protocol.

The device may be a mobile communications device.

After the device is authenticated a token may be transmitted to the device via the data communications network using the data communications protocol which token can be used by the device to encrypt data transmitted from the device back to the server.

The identification of the device is an MSISDN.

In one example, the transmitting of the security token request via the data communications network using a data communications protocol is either initiated by the server or the device.

The identification message from the device via the mobile communications network may be received by SMPP protocol.

### BRIEF DESCRIPTION OF THE DRAWINGS

The invention will now be described in more detail, by way of example only, with reference to the accompanying drawings in which:

FIGS. 1 shows a high-level structural diagram

FIGS. 2 shows a schematic illustration of an embodiment of a system and the flow of data and operations between the elements;

### DETAILED DESCRIPTION OF INVENTION

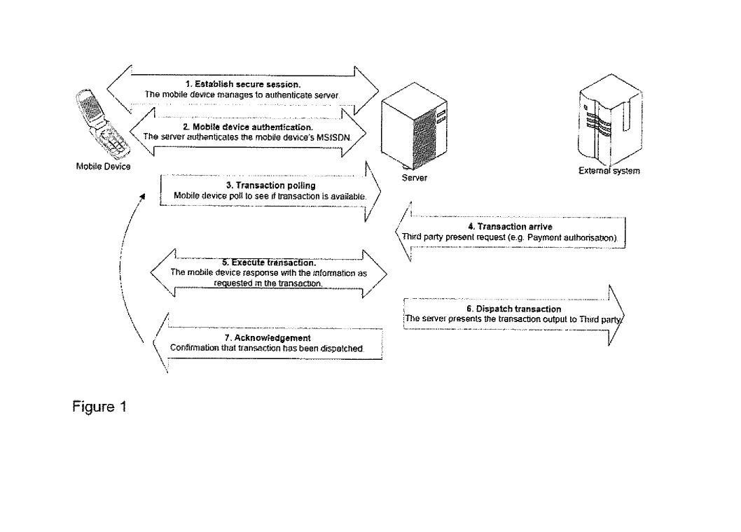

Referring to FIG. 1 of the accompanying drawings, a method of authenticating a device 10 and encrypting data transmitted between the device and a server 12 is described.

A session, with appropriate session keys, is established every time a mobile device initiates communications with the server. But authentication of the mobile device is not necessarily done every time a session is established. Once a mobile device is authenticated it becomes an authorized mobile device. An authorized device will under normal circumstances not be re-authenticated on establishing a session, but client as well as server initiated re-authentication can be forced if needed. Once a session is established all subsequent communications in both directions will be secured in the following way:
Encrypt the payload with the current session's encryption key using a symmetric cryptographic algorithm (e.g. DES, AES, etc).
Calculate a Message Authentication Code (MAC) over a so-called Authentication Code (AuthCode), the Session Identifier (SessID) and the encrypted payload using the current session's signing (MAC) key. The AuthCode can be omitted in server-originated communications.
Construct the message through concatenating the SessID, encrypted payload and MAC. The SessID can be omitted in server-originated communications.

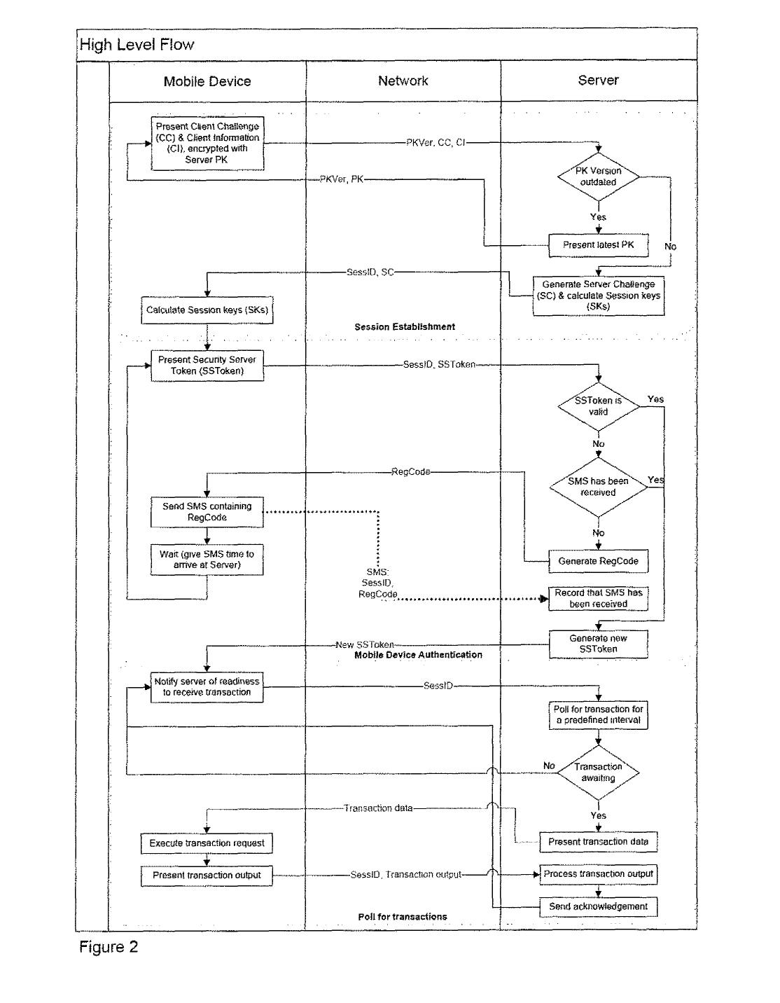

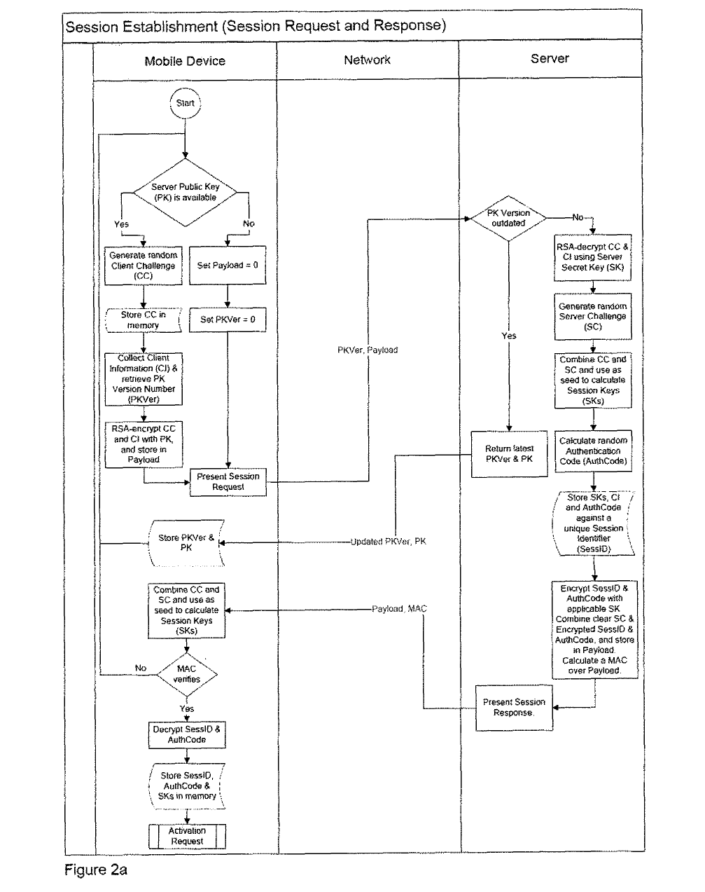

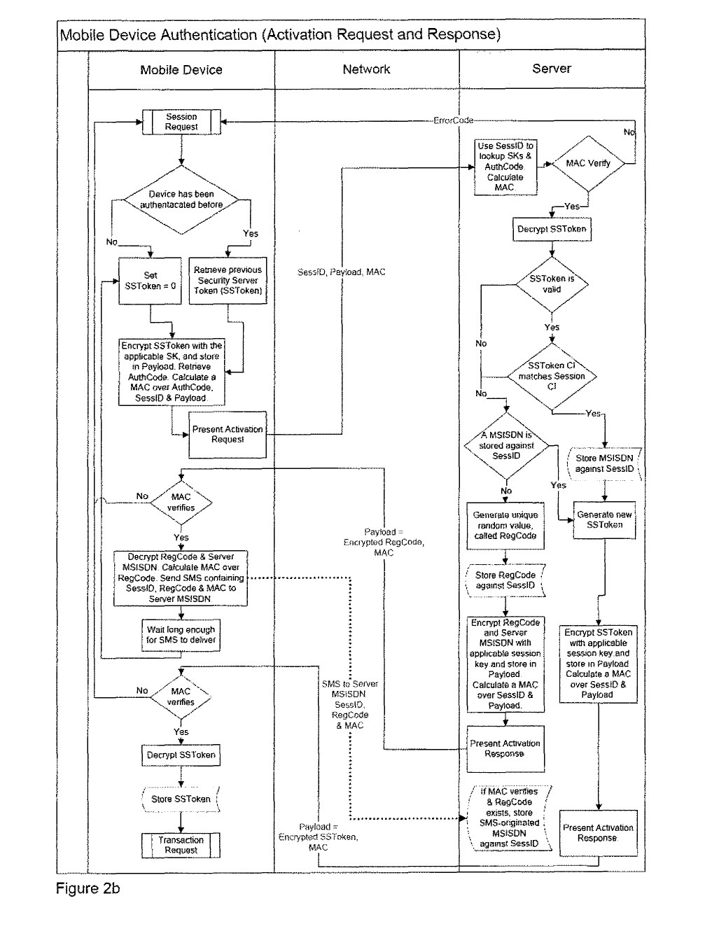

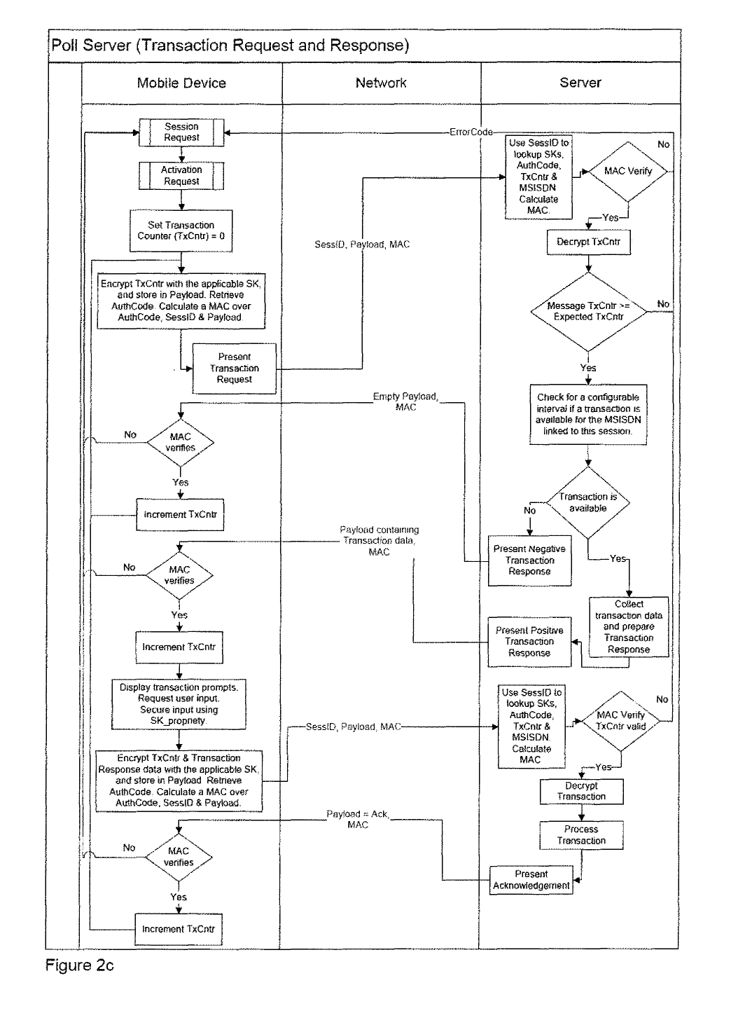

Referring to FIG. 2 of the accompanying drawings, the details of each component (Session establishment, Mobile Device authentication, and Mobile polling transaction) are described.

In the illustrated embodiment, the device 10 is shown as a mobile telephone handset. However, the device could be any other device suitable for communicating over a mobile communications network. Examples of such devices are personal or laptop computers with a mobile communications network access device or a tablet type device with a mobile communications network access device, for example.

The device 10 has certain properties that can be utilized to identify the device in a unique manner. Some of these properties include the Mobile Subscriber Integrated Services Digital Network Number (MSISDN), the International Mobile Equipment Identity (IMEI), the International Mobile Subscriber Identity (IMSI) and the Integrated Circuit Component Identifier (ICCID). Collectively all these properties are referred to as Client Information (CI).

The IMEI is a number, usually unique, used to identify GSM, WCDMA, and iDEN mobile phones, as well as some satellite phones.

The IMEI number is used by digital cellular networks such as the (Global System for Mobile Communications) GSM network to identify valid devices.

The IMEI is only used for identifying the device and has no permanent or semi-permanent relation to the subscriber. Instead, the subscriber is identified by transmission of a subscriber identifier number which in one example is a service-subscriber key (IMSI) number, which is stored on a SIM card that can (in theory) be transferred to any mobile device.

The ICC ID is used for identifying the SIM inside the mobile device. The MSISDN is used for identifying the mobile subscriber and is linked to the SIM in the device.

In any event, the methodology of the present invention commences with the loading of an application onto the mobile device 10.

The application could be loaded at any suitable time including at the time of manufacture or alternatively at a later point in time upon user selection either by sending a request from the device itself to the server 12 or by sending a request from another computer to the server 12.

Once loaded, the application can either be set to automatically execute or can be set to only execute upon user selection.

The application will access a memory and or the SIM of the mobile device 10 and obtains as many of the properties constituting CI.

The application then generates a first random number hereinafter referred to as the client challenge (CC). This number is either truly random or pseudo random and can be any number in the range 0 to 2¹²⁸.

The CC number is stored in a memory of the mobile communications device.

The application running on the mobile device 10 obtains a server public key which is a publicly available encryption key. The application will either have this stored in the code of the application or will send a request to the server 12 to obtain this encryption key.

The application then encrypts the CC using the server public key and transmits this with the CI over the mobile communications network to the server 12.

The CI may be encrypted or not when first transmitted.

The encrypted CC and CI are received by the server 12 which decrypts the CC (and possibly CI) using the server secret key, which corresponds to the server public key, and is used for decryption.

The server now generates a second random number which will hereinafter be referred to as the server challenge (SC). The SC is a random number in the range 0 to 264.

The server 12 now combines the CC and SC to get a seed number. In the illustrated embodiment, the CC and SC were combined by simply appending the SC to the CC but it will be appreciated that in other embodiments more complex combinations could be employed.

The seed number is then used to calculate four or more session keys which will be referred to as

SK_enc—a key to encrypt server data and to decrypt server data received on the mobile device.

SK_dec—a key to encrypt mobile device data and to decrypt mobile device data received at the server.

SK_mac—a key to sign (MAC) server data and to verify server signatures on the mobile device.

SK_macver—a key to sign (MAC) mobile device data and to verify mobile device signatures at the server.

SK_propriety—one or more keys to encrypt sensitive financial banking information (e.g. Bank PIN) supplied at the mobile device in a format (e.g.

ISO-0 PIN block) as prescribed by financial institutions. Any encryption with SKpropriety on the mobile device happens before any encryption with SK_dec.

The server then generates a third random number which will be referred to as AuthCode. The AuthCode may be unique but is not necessarily unique.

The server assigns a unique Session Identifier (SessID) to identify all future traffic on the particular session.

The server next encrypts the SessID and AuthCode with the SK_enc session key.

The encrypted SessID and AuthCode and the clear SC are signed using the SK_mac session key. All this data is transmitted back via the mobile communications network to the mobile device 10.

It will be appreciated that the Message Authentication Code (MAC) is the result obtained when signing data. Usually its a 4-byte (8 hexadecimal digits) value.

The application running on the mobile device 10 is now able to access the CC stored in memory and combine this with the received SC to rebuild the seed number which can then be used to calculate the four session keys (SK_enc, SK_dec, SK_mac and SK_macver) and any SK_propriety keys.

These session keys are stored in application memory on the device, and will only be kept in memory for the duration of the session.

The session key SK_mac is used to verify the signature (MAC) received from the server. A positive verification serves as proof that the calculated session keys on the mobile device are the same as the session keys on the server. Upon successful verification, the relevant session key, SK_enc, is then used to decrypt the SessID and the AuthCode.

A Transaction Counter (TxCntr), initialized to the value 1, the SessID and the AuthCode are persisted in application memory, but only for the duration of the session. The SessID and TxCntr are included in all future mobile device initiated communications to enable the server to identify the applicable session keys. The AuthCode is used as silent data when the application signs content to be delivered to the server. Although the AuthCode is always used when calculating the MAC for server-terminated messages, it is never included in the actual message. The TxCntr is increased with a value of one every time a server-terminated message is compiled.

The abovementioned process to establish a session between the mobile device and server is done every time the application on the mobile device is invoked. A new session is established should any session related issues errors been experienced inside an existing session.

A successful response to a mobile device initiated Session Establishment request is always followed by a Mobile Device Authentication request. This is typically also initiated on the mobile device but may be server initiated.

The mobile device authenticates the server during session establishment (only the server has access to the secret key to decrypt the mobile device's CC). The role of the Mobile Device Authentication request is to authenticate the mobile device to the server. The CI can play a role in authenticating the mobile device, but the aim is to gather identity information outside the application domain on the mobile device and then send this information out-of-band (on a different communication channel) to the server.

The strategy is to do mobile device authentication on first usage and then only occasionally thereafter. This is to avoid unnecessary delays when setting up communications between the mobile device and server.

The mobile device presents an encrypted Security Server Token (SSToken) to the server. The encryption is done using the Sk_dec session key. SSToken is an encrypted server-generated token (encrypted with a key only available on the server) consisting of a random part, a session counter and a reference to a database entry containing information on the mobile device. The mobile device presents an empty SSToken when doing the authentication request for the first time. In all other cases, the SSToken returns the SSToken presented in the previous authentication response (the server always returns a new SSToken to the mobile device upon successful completion of the authentication request).

The server, upon receiving the authentication request, verifies the MAC and then decrypts the SSToken using the SK_dec key. The SSToken, if not set to zero, is validated in the following way:
Decrypt the token with the server-only key.
Check that a hash value in the clear token is valid (this confirms that the data in the clear token is valid).
Lookup the database entry referred to in the token. This entry contains mobile identity information obtained from the mobile device in previous sessions.
Compare the counter in the token to the counter in the mobile identity information.
Compare the CI linked to the SessionID with the CI in the mobile identity information.

Upon successful validation, the MSISDN of the mobile device, located in the persisted identity information, is stored against the SessID. Also, a new SSToken that differs from the current SSToken is calculated. The new token is different because:
The random part of the clear token is re-generated and should therefore be different to the previous random part.
The counter value in the new token is one more than the counter value in the previous token.

The new SSToken is encrypted with the SK_enc session key, signed with the SK_mac key, and then transmitted to the mobile device as the response to the Mobile Device Authentication request.

In all cases where the SSToken is not validated (including case where SSToken is set to zero), a check is done to see if a MSISDN is stored against the SessID. (There will never be a MSISDN against the SessID on the first Authentication request with a zero or invalid SSToken.)

Upon confirmation of the non-existence of a MSISDN against the SessID, the server generates a unique random registration code hereinafter referred to as RegCode. The RegCode is the code that will be used in the database as the linking piece for all information which is why this number must be unique.

Typically, a random number is generated and then a check conducted against existing RegCode's to see if it is unique. If it is not unique, a random number is re-generated until uniqueness is achieved.

The unique RegCode is stored in the memory against the SessID.

The new RegCode and the Server MSISDN (the destination number to be used by the mobile device when compiling a SMS) is encrypted with the SK_enc session key, signed with the SK_mac key, and then transmitted to the mobile device as the response to the Mobile Device Authentication request.

At the mobile device, the MAC in the Mobile Device Authentication response is verified using SK_mac; and the content is decrypted using SK_enc. If the content is a new SSToken, the value of the token is persisted in the mobile device application and the mobile device is now ready to poll for transaction data.

But if the content is a RegCode and a Server MSISDN, the mobile device is request to proof its identity using out-of-band communications.

The RegCode is now signed with the session key SK_macver and the SessID, the signed RegCode and the MAC are transmitted back to the server using the Short Message Peer-to-Peer (SMPP) protocol.

The SMPP is a telecommunications industry protocol for exchanging SMS messages between SMS peer entities such as short message service centers and/or External Short Messaging Entities. It will be appreciated that future equivalent non session based protocols could also be used for this transmission

It will be appreciated that because the SMPP protocol is being used the SMS message being received back at the server 12 will include data therein identifying the Mobile Subscriber Integrated Services Digital Network Number (MSISDN).

Thus the server 12 can verify the MAC received in the SMS using one of the session keys (SK_macver) and if this verifies and the received RegCode is the same as the expected RegCode, then the MSISDN is stored against the SessID.

The mobile device, after submitting the SMS message, waits for a configurable time period to pass (typical a few seconds), before resubmitting the Mobile Device Authentication request. The mobile device receives an SSToken if the server has received the SMS in the meantime, and this then concludes the authentication. Otherwise, the mobile device receives another RegCode to re-attempt an SMS to the Server.

This completes the first level of authorization of the mobile device 10. Mutual authentication has been achieved at this stage: the mobile device has authenticated the server (only the server has access to the server secret key), and the server has authenticate the mobile user (the mobile user has presented the correctly signed RegCode to the server through a channel exposing the origin (MSISDN) of the mobile user).

In summary, a Mobile Device Authentication request always follows a Session Establishment request. The server always response with a RegCode on the first Mobile Device Authentication request (because SSToken is zero invalid), and this will trigger an out-of-band message to authenticate the mobile device's identity to the server. Out-of-band authentication will be the exception in subsequent Mobile Device Authentication requests (because the mobile device can present a valid SSToken), but it will be appreciated that out-of-band authentication can be forced on either side (server or mobile device) should security requirements dictate this. The mobile device forces out-of-band authentication through setting the SSToken to zero in a Mobile Device Authentication request. The server forces out-of-band authentication through additional checks when validating the SSToken (e.g. allow only a limited number of sessions per device before reverting to out-of-band, forces out-of-band after a time interval since the last out-of-band has expired, etc).

The next step is to do the Transaction request. The mobile device simply polls the server for any transactions that may have arrived at the server. It will be appreciated that various type of transactions is possible. One possible type of transaction envisioned is a payment authorization transaction, where a user instructs the payment of goods on a merchant's web site, and the authorization request (request to enter a PIN) goes to the user's mobile device as determined by the MSISDN linked to the user's bank account.

The logic is that the mobile device will continuously issue Transaction requests. Should a transaction (e.g. PIN authorization request) be available for the particular mobile device, the server returns the details of the transaction (e.g. prompts to display, information to request, etc). The mobile device executes the transaction, and then responds to the server with information provided by the mobile device user. All communications is secured using the session keys. Specific information (e.g. Bank card numbers and PIN) can be protected using any SK_propriety key. Any security applied through SK_propriety keys is applied before the standard session key security (encryption and signing of the payload as a whole) is applied. A counter, TxCntr, is included in messages originating at the mobile device to ensure that replay of messages cannot happen.

Sensitive third party information (e.g. mobile device user's bank PIN with the bank as the third party) is never exposed at the server. Such data is decrypted and re-encrypted with a key known to the third party (this process is known as PIN data translation and is always done inside a Hardware Security Module (HSM) to ensure that the PIN data is never exposed in the clear.

A technique to achieve a sufficient level of mutual authentication between an application on a mobile device (client side) and the legitimate back-end infrastructure (server side). The client authenticate the server using the typical Public/Private Key Infrastructure (PKI), knowing that only the legitimate server has access to its own (the server's) Private Key. The server authenticates the client using an out-of-band channel (e.g. SMS) to confirm the client's identity, where the client's identity is the phone number linked to the SIM in the mobile device.

Thus it will be appreciated that the method comprises:
1. A technique to establish a session between the mobile device and the server using cryptographic security similar to Secure Socket Layer (SSL) protocol. The technique can be seen as a lightweight SSL specifically adjusted for the mobile environment (less handshaking, smaller payload, and fewer up and down links up to the point where session keys are established). The major purpose of establishing a session is to get to a point where the mobile device can communicate with the server (and vice versa) in a secure way using a shared set of cryptographic keys.
2. A technique to determine whether a particular mobile device is authorized to use the add-on services that maybe available at the server
3. A technique to authenticate an un-authorized mobile device using an out-of-band communication channel.
4. A methodology to secure all data travelling from mobile device to server and back in a consistent manner.

The invention enables the secure transmission of sensitive information (e.g. financial payment information: credit and debit card numbers, PINs, etc) from a mobile device to the associated server and then onwards to a service provider third party (e.g. financial institution including banks or card associations) without exposing the sensitive information at any point.

It will be appreciated that the method allows encrypting a PIN, for example, which comprise two specific things:

1) The identification of the device is critical so two separate channels are used, one to initiate the request for device ID and confirmation of device ID comes back via alternate channel. The response is automatically sent from the device.

2) Then the same channel is used to send a token to enable the encryption to occur on the device.

1. A method of authenticating a device for secure communications between the device and a server, the method comprising:
transmitting a security token request via a data communications network using a data communications protocol;
receiving a message from the device that no security token is available;
transmitting an identification request from the server to the device via the data communications network using the data communications protocol;
receiving an identification message from the device via a mobile communications network using a mobile communications protocol, the identification message including an identification of the device;
storing the identification of the device in a memory;
generating a security token and transmitting the security token to the device via the data communications network using the data communications protocol; and
storing the security token associated with the identification of the device in a memory connected to the server for use in future secure communications with the device via the data communications network using the data communications protocol.

2. A method according to claim 1 wherein the device is a mobile communications device.

3. A method according to claim 1 wherein after the device is authenticated a token is transmitted to the device via the data communications network using the data communications protocol which token can be used by the device to encrypt data transmitted from the device back to the server.

4. A method according to claim 1 wherein the identification of the device is an MSISDN.

5. A method according to claim 1 wherein the transmitting of the security token request via the data communications network using a data communications protocol is either initiated by the server or the device.

6. A method according to claim 1 wherein the identification message from the device via the mobile communications network is received by SMPP protocol.
